(19) United States
(12) Patent Application Publication
(10) Pub. No.: US 2010/0075698 A1
(43) Pub. Date: Mar. 25, 2010

(54) LOCATION REGISTRATION AND PAGING IN TELECOMMUNICATIONS NETWORK

(75) Inventors: Johan RUNE, LIDINGO (SE); Arne NOREFORS, STOCKHOLM (SE); Tomas NYLANDER, Varmdo (SE); Jari VIKBERG, Jarna (SE)

Correspondence Address: NIXON & VANDERHYE, PC, 901 NORTH GLEBE ROAD, 11TH FLOOR, ARLINGTON, VA, 22203, US

(73) Assignee: TELEFONAKTIEBOLAGET L M ERICSSON (PUBL), Stockholm (SE)

(21) Appl. No.: 12/236,220

(22) Filed: Sep. 23, 2008

(51) Int. Cl. H04W 68/00

(52) U.S. Cl. 455/458

(57) ABSTRACT

Methods and apparatus are provided for operating a telecommunications network (20) which comprises at least one femtocell and at least one macrocell, each femtocell and each macrocell being associated with a Tracking Area. The method comprises (when a wireless terminal (30) accesses a femtocell or possibly a cell in the vicinity of the femtocell) including an identifier of the femtocell in a Tracking Area Identity list provided to the wireless terminal (30), and thereby enabling the wireless terminal (30) to avoid performing a Tracking Area Update when moving between the femtocell and another tracking area included in the Tracking Area Identity list. The method also comprises (when the wireless terminal (30) is to be paged) initially issuing a paging message only to a portion of the cells having corresponding identifiers included in the Tracking Area Identity list. Optionally the method also comprises determining that the wireless terminal (30) is accessing the telecommunications network (20) through a femtocell.

This application is related to U.S. Provisional Patent Application 61/______ (attorney docket: 2380-1270), filed Sep. 23, 2008, entitled “Method and Arrangement in a Cellular Network with Femtocells”, which is incorporated by reference herein in its entirety.

### TECHNICAL FIELD

This invention pertains to telecommunications, and particularly to the location registration and paging of wireless terminals in a telecommunications network comprising cells such as micro or femtocells.

### BACKGROUND

In a typical cellular radio system, wireless terminals (also known as mobile stations and/or user equipment units (UEs)) communicate via a radio access network (RAN) to one or more core networks. The wireless terminals can be mobile stations or user equipment units (UE) such as mobile telephones (“cellular” telephones) and laptops with wireless capability, e.g., mobile termination, and thus can be, for example, portable, pocket, hand-held, computer-included, or car-mounted mobile devices which communicate voice and/or data with radio access network.

The radio access network (RAN) covers a geographical area which is divided into cell areas, with each cell area or group of cell areas being served by a base station, e.g., a radio base station (RBS), which in some networks is also called “NodeB” or “Node B”. A cell is a geographical area where radio coverage is provided by the radio base station equipment at a base station site. Each cell is identified by an identity within the local radio area, which is broadcast in the cell. The base stations communicate over the air interface operating on radio frequencies with the user equipment units (UE) within range of the base stations.

In some versions of the radio access network, several base stations are typically connected (e.g., by landlines or microwave) to a radio network controller (RNC). The radio network controller, also sometimes termed a base station controller (BSC), supervises and coordinates various activities of the plural base stations connected thereto. The radio network controllers are typically connected to one or more core networks.

The Universal Mobile Telecommunications System (UMTS) is a third generation mobile communication system, which evolved from the Global System for Mobile Communications (GSM), and is intended to provide improved mobile communication services based on Wideband Code Division Multiple Access (WCDMA) access technology. UTRAN is essentially a radio access network using wideband code division multiple access for user equipment units (UEs). The Third Generation Partnership Project (3GPP) has undertaken to evolve further the UTRAN and GSM based radio access network technologies.

Specifications for the Evolved Universal Terrestrial Radio Access Network (E-UTRAN) are ongoing within the 3^{rd} Generation Partnership Project (3GPP). Another name used for E-UTRAN is the Long Term Evolution (LTE) Radio Access Network (RAN).

Long Term Evolution (LTE) is a variant of a 3GPP radio access technology wherein the radio base station nodes are connected directly to a core network rather than to radio network controller (RNC) nodes. In general, in LTE the functions of a radio network controller (RNC) node are performed by the radio base stations nodes. As such, the radio access network (RAN) of an LTE system has an essentially “flat” architecture comprising radio base station nodes without reporting to radio network controller (RNC) nodes.

The evolved UTRAN (E-UTRAN) comprises evolved base station nodes, e.g., evolved NodeBs or eNodeBs or eNBs, providing evolved UTRA user-plane and control-plane protocol terminations toward the wireless terminal. The eNB hosts the following functions (among other functions not listed): (1) functions for radio resource management (e.g., radio bearer control, radio admission control), connection mobility control, dynamic resource allocation (scheduling); (2) selection of a mobility management entity (MME) when no routing to an MME can be determined from the information provided by the user equipment unit (UE); and (3) User Plane functions, including IP Header Compression and encryption of user data streams; termination of U-plane packets for paging reasons, and switching of U-plane for support of UE mobility. The eNB hosts the PHYsical (PHY), Medium Access Control (MAC), Radio Link Control (RLC), and Packet Data Control Protocol (PDCP) layers that include the functionality of user-plane header-compression and encryption. The eNodeB also offers Radio Resource Control (RRC) functionality corresponding to the control plane.

The eNodeB performs many functions including radio resource management, admission control, scheduling, enforcement of negotiated UL QoS, cell information broadcast, ciphering/deciphering of user and control plane data, and compression/decompression of DL/UL user plane packet headers.

The core network where E-UTRAN is connected to is called the Evolved Packet Core (EPC), a.k.a. System Architecture Evolution (SAE) network. Both the E-UTRAN and the EPC comprise together the Evolved Packet System (EPS) that is also known as the SAE/LTE network. As indicated above, a base station in this concept is called eNodeB or eNB (E-UTRAN NodeB).

The specifications/studies for Long Term Evolution (LTE) and System Architecture Evolution (SAE) also include the possibility of having an E-UTRAN base station to provide home or small area coverage for a limited number of users. Such a home or small area coverage base station is herein also called HeNB (Home eNodeB). For UTRAN (WCDMA), this type of home access point is called HNB (Home NodeB).

The HeNB can provide normal radio coverage for the end users and can be connected to the mobile core network using, e.g., some kind of IP based transmission. As used herein, the radio coverage provided by the HeNB is called a “femtocell”.

An example impetus for providing femtocell-type of local access is to provide cheaper call or transaction rates/charges for a wireless terminal when connected via the HeNB as compared to when the wireless terminal is connected via the eNB.

Another impetus is reducing the load on the operator's eNBs and backhaul connections, thereby reducing the operator's capital expenditures and operating expenditures.

The HeNB can, in most cases, use the end user's already existing broadband connection (e.g. xDSL, Cable) to achieve connectivity to the operators mobile core network and possibly to other eNBs/HeNBs. Over the broadband connection and other possible intermediate IP networks (e.g. in the internet) a HeNB communicates with the core network nodes in the operator's network via an IPsec tunnel (Internet Protocol security architecture according to RFC 4301), which is established between the HeNB and a Security Gateway (SEGW), which protects the border of the operator's network.

FIG. 1 shows an exemplary LTE/SAE network with both femtocells and macrocells. FIG. 1 shows also a HeNB concentrator node (another name used for the HeNB concentrator node is HeNB GW (HeNB Gateway). Although not shown in FIG. 1, in at least some configurations a Security Gateway (SEGW) can be logically placed between the HeNB and the HeNB GW and can serve for terminating IPsec tunnels from the HeNB.

Situating a HeNB GW between the HeNBs and the core network (CN) addresses the following issues:
1. The assumed number of HeNBs in a network can be very high (millions of HeNBs is one estimate).
2. End users may switch on and off the HeNB frequently causing increased signaling load.
3. HeNBs may be tampered with (e.g. malicious/modified software).

The first issue creates a possible scaling problem in the core network (CN) side, since each HeNB will have its own S1 interface. An S1 interface is an interface which exists between an eNB and a Mobility Management Entity (MME) [e.g., a S1-MME] and which also can exist between an eNB and a serving Gateway [e.g., a S1-U, wherein “U” stands for “user plane”]. It is assumed that the MMEs are not capable of handling millions of S1 interfaces.

The second issue creates a possible signaling load problem in the core network (CN) side, and this mostly in the Mobility Management Entity (MME) due to HeNB S1 interfaces being frequently disconnected and reconnected.

The third issue creates a possible security problem in both the Mobility Management Entity (MME) and Serving GW as any HeNB that is able to establish an IPsec tunnel (Internet Protocol security architecture according to RFC 4301) to a security gateway of the operator's network may attack these nodes.

Thus, the HeNB GW (HeNB Gateway) is needed to solve these scaling, signaling load and security issues.

A concept known as CSG (Closed Subscriber Group) has been introduced into the SAE/LTE 3GPP standards and may also be introduced into the WCDMA/UTRAN 3GPP standard. With CSG, particular HeNBs can be associated to certain UEs, meaning that only these associated UEs are allowed to access the HeNBs. In actuality, a CSG is associated with a group of subscribers rather than with UEs, but for simplicity the term UE will often be used as the entity of which a CSG is formed. The allowed CSG Identities (CSG-ID) are stored in the UE in a so called CSG Whitelist. Each HeNB broadcasts in System Information (SI) both a “CSG Indicator” (Boolean type of indicator) and the CSG-ID allocated to it. This means that a UE can determine (by reading the CSG-ID from the SI and comparing this to the contents of the CSG Whitelist) whether it is allowed to access a particular HeNB. The allowed CSGs (Closed Subscriber Groups) for a UE are also stored in the Core Network (CN), so that the Core Network (CN) can perform an ultimate access control, e.g. in case a UE has an outdated CSG Whitelist or misbehaves (e.g. a hacked UE).

A new principle has been introduced for location registration in the SAE/LTE networks. This principle is based on a Tracking Area (TA) concept. The Tracking Area (TA) concept is in limited fashion similar to Location Areas (LA) and Routing Areas (RA) in GSM and WCDMA networks. In particular, each SAE/LTE cell belongs normally to a single Tracking Area (TA) (if not considering RAN sharing deployments) and a Tracking Area Identity (TAI) is broadcasted as part of the System Information (SI). The current assumption is that the Tracking Area Identity (TAI) will consist of a Mobile Country Code (MCC), a Mobile Network Code (MNC) and a Tracking Area Code (TAC).

A difference of the Tracking Area (TA) concept as opposed to the LA/RA concepts is that in SAE/LTE a concept called multiple TAs or TAI List has been introduced. This means that the network may return a TAI List to the UE as part of some EPS Mobility Management (EMM) procedures such as Attach, Tracking Area Update (TAU), and Globally Unique Temporary Identifier (GUTI) Reallocation. As long as the UE camps on a cell belonging to a TA whose TAI is included in the TAI List, the UE does not perform normal TAUs (although periodic TAUs are still performed). The UE performs a normal Tracking Area Update (TAU) first when it moves to a cell that does not belong to a TA in the TAI List. As part of this Tracking Area Update (TAU) the UE will receive a new TAI List and the same procedure continues.

This principle is further shown in FIG. 2A and FIG. 2B. FIG. 2A shows the case when the wireless terminal has performed, e.g. a Tracking Area Update (TAU) and has received a TAI List of {TA1, TA2, TA3} from the Core Network (CN). This means that the wireless terminal can move within TA1, TA2 and TA3 without performing a Tracking Area Update (TAU). In FIG. 2A and FIG. 2B, the notation TA1, TA2, etc. is used to denote both Tracking Area 1, Tracking Area 2, etc. and the TAIs of these Tracking Areas, depending on the context. For instance, when used to represent the TAI List, then TA1, TA2, etc. represent the TAIs in the list (i.e. the TAIs of Tracking Area 1, Tracking Area 2, etc.), whereas when it is stated that the wireless terminal can move freely within TA1, TA2, etc., then the terms TA1, TA2, etc. represent the actual Tracking Areas. The wireless terminal in FIG. 2A is also moving towards the TA4 that is further described in FIG. 2B.

In FIG. 2B, the wireless terminal performs a TAU when it moves to a cell belonging to TA4. After performing a successful Tracking Area Update (TAU) in TA4, as shown by the arrows in FIG. 2B the wireless terminal receives TAI List {TA2, TA3, TA4} from the Core Network (CN). Now the wireless terminal can move within TA2, TA3 and TA4 without the need to perform a TAU.

One purpose with the Tracking Area Update (TAU) is to provide information about the location of the wireless terminal to the network. This information can then be used, e.g., for paging purposes for mobile terminating transactions, e.g., to locate the wireless terminal and to establish a signaling connection between the wireless terminal and the network. The network needs to page the wireless terminal in all the Tracking Areas (TAs) represented by the whole TAI List, e.g., in all the cells belonging to any of the TAs whose TAIs are included in the TAI List. For example, considering the scenario above in FIG. 2B, the network would need to page the wireless terminal in all cells belonging to TA2, TA3 or TA4.

What is needed therefore, and an object of the technology described herein, are apparatus, methods, and procedures to enhance Tracking Area (TA) handling.

Advantages of the technology described herein are enhanced handling of the related signaling load for Tracking Area Updates (TAUs) and paging in a SAE/LTE network with femtocells.

### SUMMARY

The technology described herein encompasses methods and apparatus for operating a telecommunications network which comprises at least one femtocell and at least one macrocell, the at least one femtocell and the at least one macrocell being associated with a Tracking Area. An aspect of the disclosed technology comprises a method which comprises (when a wireless terminal accesses or is about to access a femtocell) including an identifier of the femtocell in a Tracking Area Identity list provided to the wireless terminal, and thereby enabling the wireless terminal to avoid performing a Tracking Area Update when moving between the femtocell and another tracking area included in the Tracking Area Identity list. In another of its aspects the method also comprises (when the wireless terminal is to be paged) initially issuing a paging message only to a portion of the cells having corresponding identifiers included in the Tracking Area Identity list. Optionally the method also comprises determining that the wireless terminal is accessing the telecommunications network through the femtocell.

The method thus encompasses a potential two-staged paging process wherein an initial paging message is sent to a first portion of a Tracking Area Identity list and, if necessary, a subsequent paging message is sent to a second or remaining portion of a Tracking Area Identity list. In a one example mode or embodiment, the act of issuing a paging message further comprises initially issuing a first paging message only to a first set of cells (e.g., to a femtocell(s)) having its/their corresponding identifier(s) included in the Tracking Area Identity list, and if the wireless terminal does not respond to the first paging message, issuing a second paging message to another set of cells having corresponding identifiers included in the Tracking Area Identity list.

In another example mode or embodiment, the act of issuing a paging message further comprises initially issuing a first paging message only to a cell or set of cells having its/their corresponding identifier/identifiers included in the Tracking Area Identity list and with which the wireless terminal had its last contact, and if the wireless terminal does not respond to the first paging message, issuing a second paging message to another set of cells having corresponding identifiers included in the Tracking Area Identity list.

In another of its aspects, the technology disclosed herein concerns a core network entity configured to communicate with a radio access network comprising at least one femtocell and at least one macrocell, the at least one femtocell and the at least one macrocell being associated with a Tracking Area. In an example embodiment, the core network entity comprises a Tracking Area Identity list builder and a paging unit.

The Tracking Area Identity list builder is configured to include an identifier of a femtocell in a Tracking Area Identity list provided to a wireless terminal when the wireless terminal accesses or is about to access the femtocell. Inclusion of the identifier avoids the wireless terminal performing a Tracking Area Update when moving between the femtocell and another tracking area included in the Tracking Area Identity list. The paging unit is configured, when the wireless terminal is to be paged, to initially issue a paging message only to a portion of the cells having corresponding identifiers included in the Tracking Area Identity list.

In one example embodiment, the paging unit is configured to initially issue a first paging message only to a first set cells comprising one or more femtocells having corresponding identifiers included in the Tracking Area Identity list, and if the wireless terminal does not respond to the first paging message, to subsequently issue a second paging message to another set of cells having corresponding identifiers included in the Tracking Area Identity list. In another example embodiment, the paging unit is configured to initially issue a first paging message only to a cell (or set of cells) having its/their corresponding identifier/identifiers included in the Tracking Area Identity list and with which the wireless terminal had its last contact, and if the wireless terminal does not respond to the first paging message, to subsequently issue a second paging message to another set of cells having corresponding identifiers included in the Tracking Area Identity list.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a schematic view of an exemplary LTE/SAE network with both femto and macrocells.

FIG. 2A and FIG. 2B are schematic views of tracking areas, with FIG. 2A showing a situation in which a wireless terminal has received a Tracking Area Identity (TAI) List which permits the wireless terminal to move within tracking areas TA1, TA2 and TA3 without performing a Tracking Area Update (TAU), and with FIG. 2B a situation in which a wireless terminal performs a Tracking Area Update (TAU) and receives another Tracking Area Identity (TAI) List which permits the wireless terminal to move within tracking areas TA2, TA3 and TA4 without performing a Tracking Area Update (TAU).

FIG. 3 is a schematic view of the tracking areas of FIG. 2A and FIG. 2B with femtocells introduced therein.

FIG. 4 is a diagrammatic view showing an example network.

FIG. 5 shows an example embodiment of a telecommunications network which encompasses the cell topography of FIG. 4.

FIG. 6 is a flowchart illustrating basic, representative, non-limiting, example acts or steps which can be performed in conjunction with a method of operating a telecommunications network such as that of FIG. 5.

FIG. 7 is a diagrammatic view showing various ways in which a Mobility Management Entity (MME) can become aware that a wireless terminal is accessing the core network through a femtocell.

FIG. 8 is a diagrammatic view showing various ways a multi-staged paging operation can occur according to example embodiments and modes.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks labeled or described as “processors” or “controllers” may be provided through the use of dedicated hardware as well as hardware capable of executing software in association with appropriate software. When provided by a processor, the functions may be provided by a single dedicated processor, by a single shared processor, or by a plurality of individual processors, some of which may be shared or distributed. Moreover, explicit use of the term “processor” or “controller” should not be construed to refer exclusively to hardware capable of executing software, and may include, without limitation, digital signal processor (DSP) hardware, read only memory (ROM) for storing software, random access memory (RAM), and non-volatile storage.

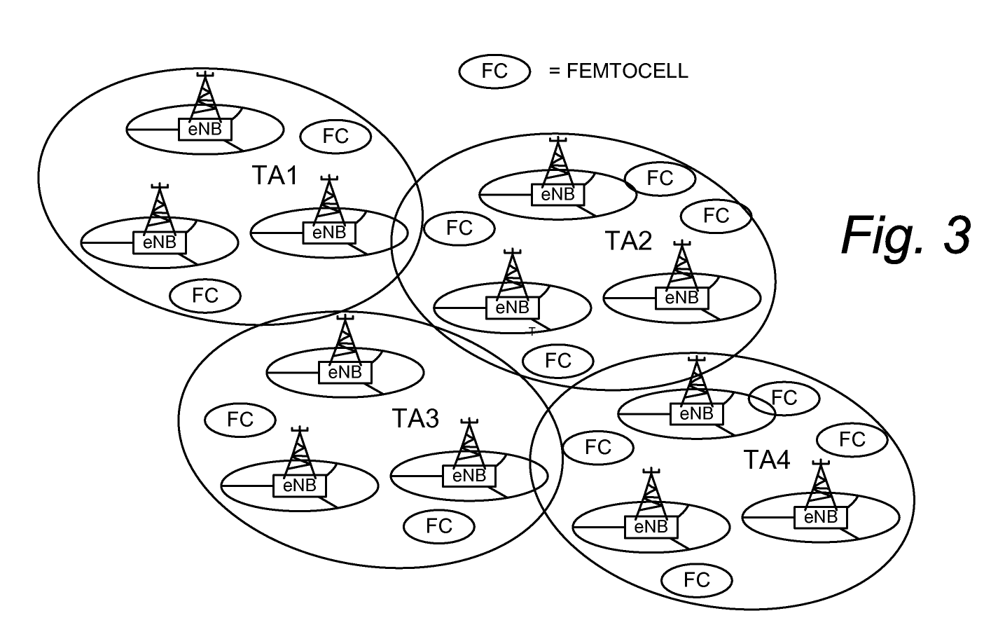

There are different Tracking Area (TA)/Tracking Area Identity (TAI) allocation mechanisms that can be used when femtocells are introduced into a SAE/LTE network. This is shown in FIG. 3 where a few femtocells are shown as being introduced in Tracking Areas TA1-TA4. The femtocells are typically installed by the end users themselves (e.g., without any intervention from the mobile operator's personnel). This means that it is not really possible to perform cell or Tracking Area (TA) planning for femtocells as is normally performed for macrocells. This leads to the assumed approach which the femtocells are each allocated one Tracking Area Identity (TAI) from a limited set of Tracking Area Identities (TAIs) and that the Tracking Area Identities (TAIs) need to be reused between different femtocells. These Tracking Area Identities (TAIs) are not used in the macrocells. Each femtocell is allocated one of these Tracking Area Identities (TAIs) during an automatic configuration procedure, normally when the HeNB is powered on. Although the limited set of TAIs used for femtocells are reused between different femtocells, a femtocell typically does not have any neighboring cells which share the same TAI.

A relevant identifier is the eNB Identity (eNB-ID). Each eNB, HeNB and HeNB GW is allocated a unique identifier that is used for handover routing and other things.

Depending on the TA/TAI allocation and the handling for femtocells, several different problems can arise. As mentioned above, it is assumed and likely that deployments will be based on that the femtocells are allocated a number of unique TAIs that are not used in the macrocells.

If the femtocells are allocated with Tracking Area Identities (TAIs) which are different from the macrocells, and these TAIs are not included in the TAI List while the wireless terminal is in the macrocells, a Tracking Area Update (TAU) would be performed each time the wireless terminal moves from macrocell to femtocell. A similar issue exists if the TAIs which are used in the macrocells are not included in the TAI List while the UE is in the femtocells, e.g., a Tracking Area Update (TAU) would be performed each time the wireless terminal moves from femtocell to macrocell. This effect would be accentuated if the femtocell coverage is poor around the border of the area that the femtocell is intended to cover, e.g., a home. In such case a user walking around in his home may cause ‘ping-pong Tracking Area Updates (TAUs)’, as he walks in and out of femtocell coverage in his own home.

If one or more TAIs allocated for femtocells are included in the TAI List, the number of TAUs can be reduced (e.g., no TAU needed while the wireless terminal moves between macrocells and femtocells). However, paging of the wireless terminal would need to be performed in both macro and femtocells belonging to any of the Tracking Areas (TAs) in the TAI List, which results in unnecessary paging load (especially in the macrocells). femtocell

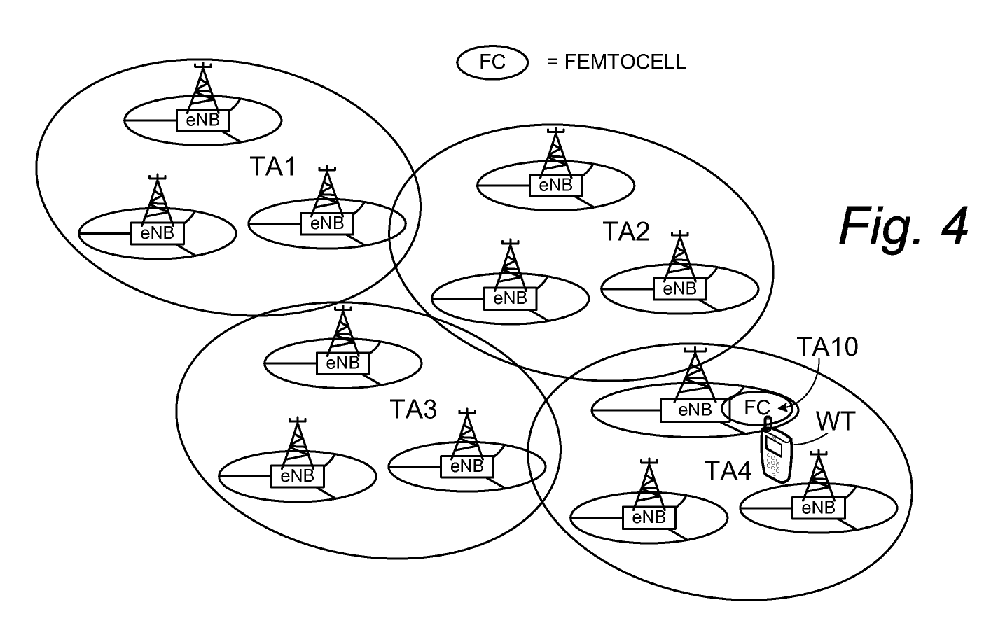

FIG. 4 illustrates example cell topography which serves as a basis for discussion of technology described herein. When a wireless terminal shown in FIG. 4 is initially in a macro cell, the TAI List for the wireless terminal is {TA2, TA3, TA4}.

The femtocell shown in FIG. 4 is an allowed femtocell for this wireless terminal and has been automatically configured to use TA10. However, at the state shown in FIG. 4, the wireless terminal has not entered the femtocell which has the Tracking Area (TA) identity of TA10.

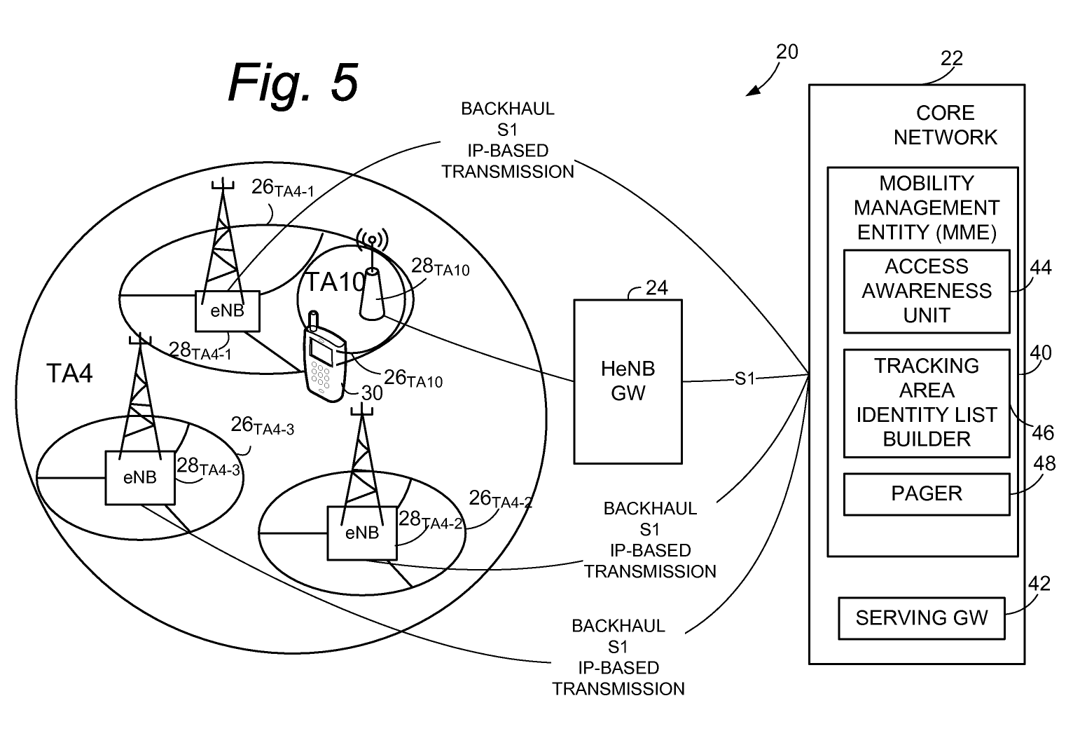

FIG. 5 shows an example telecommunications network 20 which encompasses the cell topography of FIG. 4, but which shows only the cells of Tracking Area TA4. It is to be understood that the cell topography served by telecommunications network 20 can encompass many other cells such as (by way of non-limiting example) the cells of Tracking Areas TA1, TA2, and TA3 of FIG. 4, but such other cells are not illustrated for sake of simplification.

The telecommunications network 20 of FIG. 5 comprises evolved packet core (EPC) network 22 (abbreviated “core network” in FIG. 5); HeNB concentrator node 24 (also referred to as HeNB Gateway (GW), or HeNB GW); and a radio access network comprising a cell topography such as that of FIG. 4. The radio access network shown in FIG. 5 includes macro cells 26 comprising Tracking Area TA4 of FIG. 4. For sake of simplicity, only three such macro cells 26_{TA4-1} through 26_{TA4-3} are shown in FIG. 5, but it should be understood that a different number of macro cells could be included. The macro cells 26_{TA4-1} through 26_{TA4-3} are served by respective base stations 28 (also known as eNodeBs or eNBs), e.g., base stations 28_{TA4-1} through 28_{TA4-3}.

The radio access network shown in FIG. 5 also includes at least one and preferably many femtocells, such as the representative femtocell 26_{TA10} which is shown by way of example in FIG. 5. The representative femtocell 26_{TA10} is served by home base station 28_{TA10} (e.g., HeNB 28_{TA10}). At the time shown in FIG. 5, a wireless terminal 30 is entering the representative femtocell 26_{TA10}.

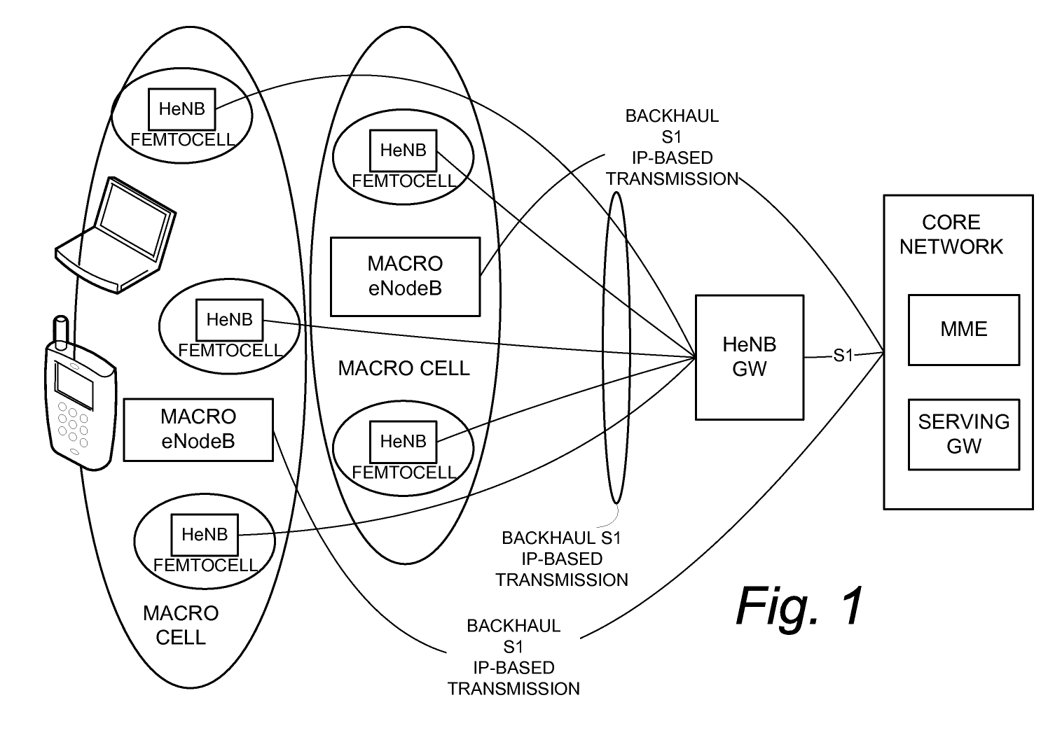

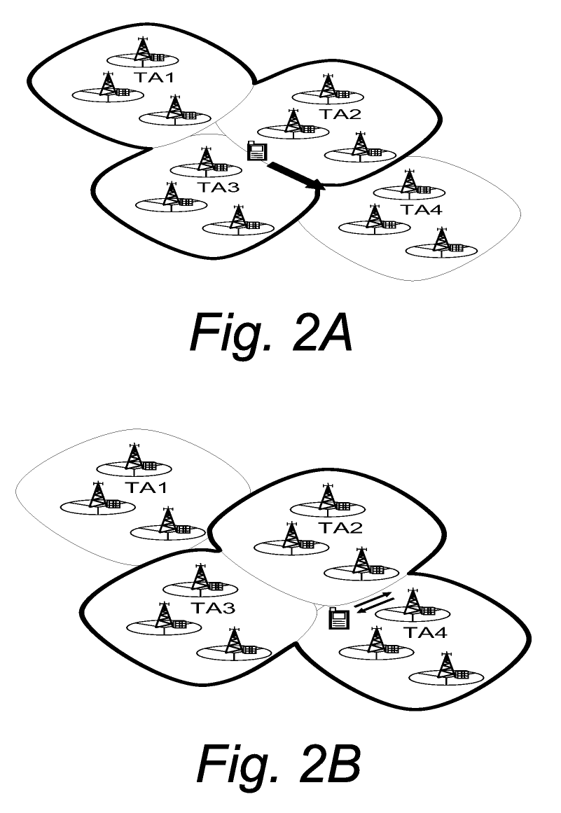

As explained with reference to FIG. 1, the base stations such as base stations 28_{TA4-1} through 28_{TA4-3} can be connected to evolved packet core (EPC) network 22 through backhaul S1 IP-based transmission, and similarly the home base stations such as home base station 28_{TA10} can be connected through backhaul S1 IP-based transmission to HeNB Gateway 24, and from HeNB Gateway 24 to evolved packet core (EPC) network 22. Although not shown in FIG. 5, in at least some configurations a Security Gateway (SEGW) can be logically placed between the HeNB and the HeNB GW and can serve for terminating IPsec tunnels from the HeNB.

As further shown in FIG. 5, evolved packet core (EPC) network 22 comprises, among other possible functional nodes or entities, Mobility Management Entity (MME) and serving gateway (GW) 42. The Mobility Management Entity (MME) 40 in turn comprises (among other units and functionalities) access awareness unit 44; Tracking Area Identity list builder 46; and a paging unit such as pager 48. The functionalities of Mobility Management Entity (MME) 40, including but not limited to the functionalities of the access awareness unit 44, Tracking Area Identity list builder 46, and pager 48, may be realized or provided by one or more processors or controllers as those terms are expansively described herein.

Mobility Management Entity (MME) 40 in the Core Network (CN) 22 is made aware of when a wireless terminal such as wireless terminal 30 of FIG. 5 is accessing or is about to access the network from a femtocell and treats that wireless terminal differently when it comes to Tracking Area Identity (TAI) List handling and paging.

Through this special treatment Tracking Area Updates (TAUs) can be minimized while still keeping the benefit of optimized paging. As explained in more detail hereinafter, basic principles encompassed by the technology disclosed herein are:
The Mobility Management Entity (MME) 40 is made aware when a wireless terminal is accessing or is about to access the network from a femtocell.
When the wireless terminal is known to be in the vicinity of its femtocell Tracking Area (TA), the Mobility Management Entity (MME) 40 adds the femtocell Tracking Area Identity (TAI) to the Tracking Area Identity list for the wireless terminal to avoid tracking area updates when the wireless terminal is moving in and out of the femtocell. One way to detect whether the wireless terminal is in the vicinity of the femtocell is to compare the Mobility Management Entity (MME) the wireless terminal is connected to with the Mobility Management Entity/Entities (MME(s)) the femtocell is connected to.
When the wireless terminal accesses or is about to access the femtocell, the Mobility Management Entity (MME) 40 adds the femtocell Tracking Area Identity (TAI) to the Tracking Area Identity list for the wireless terminal to avoid tracking area updates when the wireless terminal is moving in and out of the femtocell.
The paging for the wireless terminal can be multi-staged (e.g., two-staged). For example, in a first step or stage the paging for the wireless terminal can comprise a first page directed only to the femtocell TA, and in a second step or stage (if the first page fails) a page can be directed to the remainder of the current Tracking Area Identity list for the wireless terminal. This is done to reduce paging load as it can be assumed that the subscriber often will be in the femtocell Tracking Area (TA).

FIG. 6 illustrates basic, representative, non-limiting, example acts or steps which can be performed in conjunction with a method of operating the telecommunications network 20 of FIG. 5. Acts of FIG. 6 need not necessarily be sequential: for example, act 6-1 would not necessarily precede act 6-2. Optional act 6-1 of the method comprises determining that the wireless terminal is accessing or is about to access the telecommunications network through a femtocell. For example, in the situation shown in FIG. 5, wireless terminal 30 is beginning or attempting to access the telecommunications network 20 through femtocell 26_{TA10}.

Act 6-2 of FIG. 6 comprises including an identifier of the femtocell in a Tracking Area Identity list provided to the wireless terminal when a wireless terminal (such as wireless terminal 30 of FIG. 5) accesses a femtocell or a cell in the vicinity of a femtocell. Including the identifier of the femtocell in the Tracking Area Identity list for the wireless terminal enables the wireless terminal to avoid performing a Tracking Area Update when moving between the femtocell and another tracking area included in the Tracking Area Identity list.

Act 6-3 of the method of FIG. 6 comprises initially issuing a paging message only to a portion of the cells (having corresponding identifiers included in the Tracking Area Identity list) when the wireless terminal is to be paged.

As represented by the corresponding acts of FIG. 6, the technology described herein encompasses, e.g., the following three parts that are described in the corresponding following sections: (1.0) How the Mobility Management Entity (MME) is made aware of that a wireless terminal is accessing or is about to access the network via a femtocell; (2.0) How the MME builds the Tracking Area Identity list for the wireless terminals; and (3.0) How the Mobility Management Entity (MME) 40 performs different paging logic in some cases. Thus, the knowledge of the Mobility Management Entity (MME) 40 that the wireless terminal is accessing or is about to access the network via a femtocell can be used in both building the Tracking Area Identity list for a wireless terminal and in deciding the paging logic to be used.

1.0 Awareness of Network Access via Femtocell

Example act 6-1 described above includes determining that the wireless terminal is accessing the telecommunications network through a femtocell. The reason for the access could be, for example, a Tracking Area Update (TAU) or another Service Request triggered by the wireless terminal. Reference herein to the wireless terminal “accessing” the network via a femtocell includes scenarios of the wireless terminal being about to access the femtocell”, unless such appears otherwise from the context. Moreover, as used herein, “about to access” the network through a femtocell encompasses the possibility that a handover of the wireless terminal to the femtocell may be contemplated. As such the femtocell may be on or be eligible for inclusion on a cell list for anticipated handover or the like. For example, the act of including an identifier of the femtocell in the Tracking Area Identity list can be performed when the wireless terminal accesses a cell in the vicinity of the femtocell.

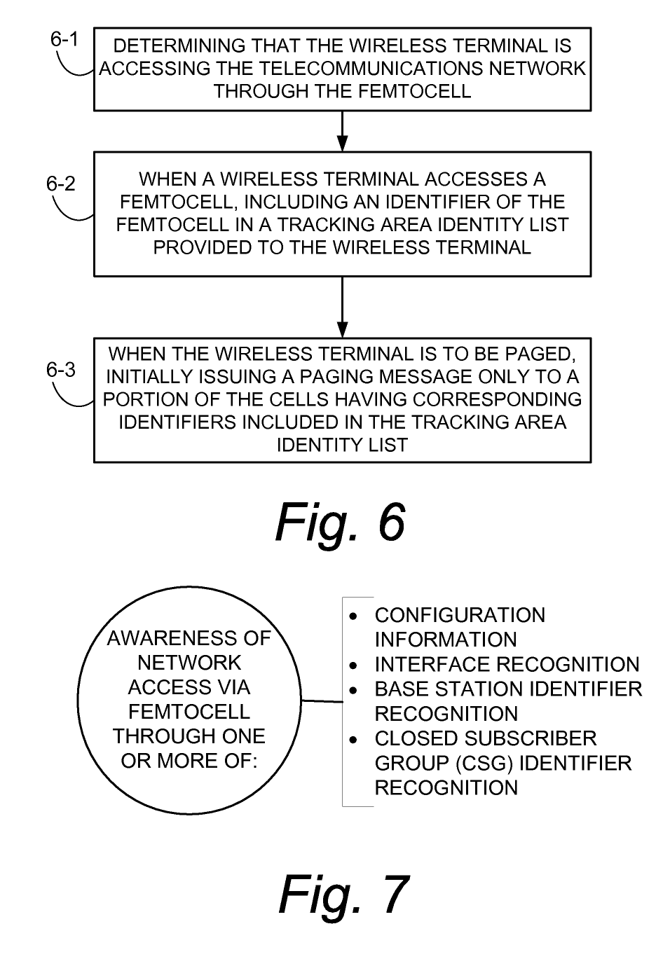

As illustrated by FIG. 7, there are several ways for the Mobility Management Entity (MME) 40 to know that the wireless terminal is accessing the network via a femtocell. Some representative example such ways are listed below and illustrated in FIG. 7.

1.1 Configuration Information

In one example embodiment and implementation, the Mobility Management Entity (MME) 40 may know (e.g., from configuration information) which Tracking Area Identities (TAIs)/TACs belong to femtocells. For example, the Mobility Management Entity (MME) 40 may comprise or have access to a table or other list which provides a correspondence between Tracking Area Identities (TAIs) and femtocells or which specifies which Tracking Area Identities (TAIs) are associated with femtocells.

1.2 Interface Recognition

The Mobility Management Entity (MME) 40 may know that the particular S1 connection by which the wireless terminal is accessing (or about to access) the network comes from a HeNB (or a HeNB GW). In other words, the Mobility Management Entity (MME) 40 may recognize the particular interface through which the access occurs as being associated with a femtocell (e.g., that the interface through which the wireless terminal is accessing the network comes from a HeNB (or a HeNB GW)). As indicated above, an S1 interface is an interface which exists between an eNB (or HeNB or HeNB GW) and a Mobility Management Entity (MME) and which also can exist between an eNB (or HeNB or HeNB GW) and a serving Gateway. The Mobility Management Entity (MME) 40 obtains this knowledge when the S1 connection is established, e.g. through information conveyed from the HeNB/HeNB GW or through configuration from a management system.

1.3 Base Station Identifier Recognition

The Mobility Management Entity (MME) 40 may know which base station identifiers (e.g., HeNB-IDs) belong to femtocells. For example, some part of the eNB-ID can identify the HeNB gateway (HeNB GW). This example is partly related to example 1.2 as the base station identifier (e.g., eNodeB-ID of the HeNB GW) is indicated to the MME as part of the S1 interface/connection establishment. This means that the interface itself can be used by the MME to know when a wireless terminal is accessing a femtocell. Another example of the usage of base station identifier is the case when handover is performed towards a femtocell. In that case, the MME is informed about the base station identifier of the target base station and can use this information to identify whether the target cell is a femtocell or not and consequently whether the wireless terminal is about to access a femtocell or not.

1.4 Closed Subscriber Group (CSG) Identifier Recognition

The Mobility Management Entity (MME) 40 may know from the CSG (Closed Subscriber Group) identifier (ID) that the wireless terminal is accessing the network via a femtocell, and which femtocell (or at least its CSG ID) it is. The CSG (Closed Subscriber Group) identifier (ID) may be conveyed from the HeNB or the HeNB GW to the MME. The Mobility Management Entity (MME) 40 preferably performs CSG-based access control for a wireless terminal and the CSG Whitelist for the wireless terminal in the Mobility Management Entity (MME) 40 indicates whether the current cell is an allowed CSG cell for the wireless terminal.

One or more of the foregoing, or any other appropriate mechanism may be employed to allow the Mobility Management Entity (MME) 40 to know that the wireless terminal is accessing the network via a femtocell. This is a consequence of the requirements that the network should be able to apply differentiated charging for CSG cells and perform CSG based access control femtocell

2.0 Building the Tracking Area Identity list

As indicated above, act 6-2 of the method of FIG. 6 comprises including an identifier of the femtocell in a Tracking Area Identity list provided to the wireless terminal when a wireless terminal (such as wireless terminal 30 of FIG. 5) accesses a femtocell or a cell in the vicinity of a femtocell. An example technique which Tracking Area Identity list builder 46 of Mobility Management Entity (MME) 40 uses to build the Tracking Area Identity list for a wireless terminal that is allowed to access femtocell(s) is described in relation to FIG. 4.

As shown in FIG. 4, when the wireless terminal accesses the femtocell (e.g., the femtocell now designated as Tracking Area TA10) the Mobility Management Entity (MME) includes the femtocell TAI (TA10) in the wireless terminal's Tracking Area Identity list. The Mobility Management Entity (MME) 40 knows that the Tracking Area Update (TAU) that is occurring is related to a femtocell using any of the methods described in section 1.0 hereof. At this point the Mobility Management Entity (MME) may also mark the TA10 as being one used for femtocells, if needed, e.g., if the Mobility Management Entity (MME) was not configured with the TAIs/TACs used in the femtocells. The Mobility Management Entity (MME) could also keep either all the macro Tracking Area Identities (TAIs) or selected ones in the wireless terminal's Tracking Area Identity list. For example, if the TAI List for the wireless terminal were {TA2, TA3, TA4} before the wireless terminal accessed the femtocell designated as TA10, then the wireless terminal would trigger a Tracking Area Update (TAU) when entering the femtocell. The Mobility Management Entity (MME) could then allocate (for example) a Tracking Area Identity list having content {TA2, TA3, TA4, TA10} (i.e. by simply adding TA10 to the existing Tracking Area Identity list).

If a wireless terminal is turned on in an allowed femtocell (i.e. if there is no valid Tracking Area Identity list when the wireless terminal contacts the Mobility Management Entity (MME) via a femtocell), there is no Tracking Area Identity list to which to add the femtocell Tracking Area (TA). Since the wireless terminal has not registered in a macro Tracking Area (TA), the Mobility Management Entity (MME) cannot yet choose any relevant macro Tracking Areas (TAs) to include in the Tracking Area Identity list of the UE and consequently it will build an initial TAI List consisting of only the femtocell TA(s) (preferably only the Tracking Area (TA) of the femtocell that the wireless terminal is accessing). When the wireless terminal subsequently leaves the femtocell and performs a Tracking Area Update (TAU) in a macro Tracking Area (TA), the Mobility Management Entity (MME) provides the wireless terminal with a new Tracking Area Identity list including relevant macro Tracking Areas (TAs). The femtocell TA(s) may or may not be included in this new Tracking Area Identity list. Typically it (they) will be included in order to avoid the occurrence of ping-pong Tracking Area Updates (TAUs).

With this technique the wireless terminal will not need to perform any Tracking Area Update (TAU) while moving between the allowed femtocell and the area covered by the macro Tracking Areas (TAs) that are included in the Tracking Area Identity list for the wireless terminal.

A significant advantage with this approach is that the signaling load due to so called “ping-pong” effect is decreased. “Ping-pong” means that the wireless terminal is constantly moving between the femtocell and the surrounding macrocell due to e.g. “spotty” femtocell coverage or the end user moving in and out from the femtocell coverage (e.g. the home).

The Tracking Area (TA) of the femtocell could be included in the Tracking Area Identity list as long as the wireless terminal has its wireless terminal context with this Mobility Management Entity (MME).

Furthermore, the Mobility Management Entity (MME) may exclude the femtocell Tracking Area (TA) from the Tracking Area Identity list of the wireless terminal when the wireless terminal performs a (normal) Tracking Area Update (TAU) in a new Tracking Area (TA), i.e. in a Tracking Area (TA) which was not included in the Tracking Area Identity list, and the Mobility Management Entity (MME) consequently allocates a new Tracking Area Identity list to the wireless terminal. Removing the Tracking Area (TA) of the femtocell from the Tracking Area Identity list results in a Tracking Area Update (TAU) being performed again the next time the wireless terminal enters its femtocell, e.g., the same behavior as described earlier.

3.0 Staged Paging/Differing Paging Logic

As indicated above, act 6-3 of the method of FIG. 6 comprises initially issuing a paging message only to a portion of the cells (having corresponding identifiers included in the Tracking Area Identity list) when the wireless terminal is to be paged.

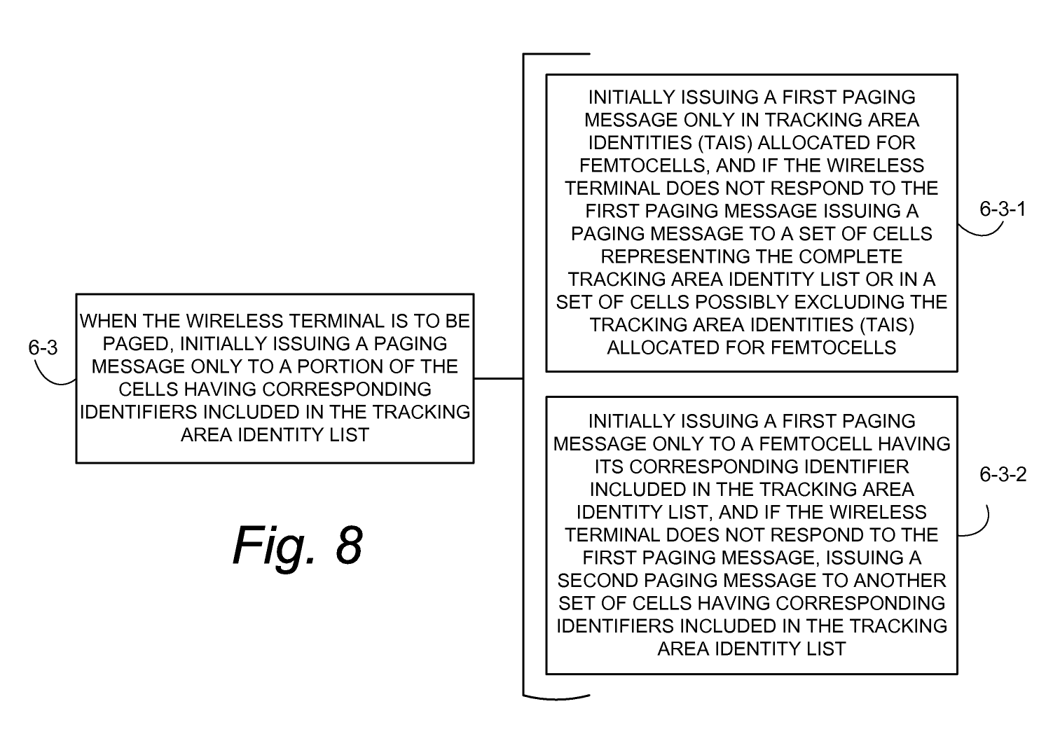

FIG. 8 illustrates two example modes or ways in which act 6-3 may be implemented.

A first way of implementing act 6-3 is depicted in FIG. 8 as act 6-3-1. According to example act 6-3-1, the act of issuing a paging message further comprises initially issuing a first paging message only to a first set of cells (e.g., to a set of one or more femtocell(s)) having its/their corresponding identifier(s) included in the Tracking Area Identity list. If the wireless terminal does not respond to the first paging message, act 6-3-1 further comprises issuing a second paging message to another set of cells having corresponding identifiers included in the Tracking Area Identity list. The another set of cells can be, for example, in separate implementations, either the entire Tracking Area Identity list or the cell(s) which were not included in the first paging message. As used herein, the “another set of cells” may also include the first set of cells. This is because the wireless terminal could be moving from the macrocells to the femtocells during the paging process in which case it may first miss the page in the femtocell as it is still in the macrocell, and then as it moves into the femtocell the wireless terminal could miss the second page if the second page covered only the macrocells. Thus, the “another set of cells” can include all, some or none of the cells of the first set of cells.

Thus, when Mobility Management Entity (MME) 40 needs to page the wireless terminal, the Mobility Management Entity (MME) 40 may start by investigating the current Tracking Area Identity list for the wireless terminal. In the example mode and embodiment depicted by act 6-3-1, if this Tracking Area Identity list contains any Tracking Area Identities (TAIs) allocated for the femtocells, the pager 48 of the Mobility Management Entity (MME) 40 first pages the wireless terminal only in these Tracking Area Identities (TAIs) allocated for femtocells. If the wireless terminal does not respond in a timely manner for the first paging, the pager 48 of Mobility Management Entity (MME) 40 pages the wireless terminal in a set of cells representing the complete Tracking Area Identity list or in a set of cells possibly excluding the Tracking Area Identities (TAIs) allocated for femtocells. This gives a step-wise increase of the paging area, e.g., initially only the femtocells are used for the paging and then moving to the whole macro area for the relevant Tracking Areas (TAs).

In another example mode or embodiment depicted by act 6-3-2 of FIG. 8, the act of issuing a paging message further comprises initially issuing a first paging message only to a cell or set of cells (e.g., comprising a Tracking Area) having its/their corresponding identifier(s) included in the Tracking Area Identity list and with which the wireless terminal had its last contact (optionally within some predefined time), and if the wireless terminal does not respond to the first paging message, issuing a second paging message to other cells (which may or may not include the cell or set of cells first paged in) having corresponding identifiers included in the Tracking Area Identity list. Thus, the pager 48 of MME Mobility Management Entity (MME) 40 may also employ optimizations such as letting the last contact it had with the wireless terminal guide or determine its paging strategy. For instance, if the last contact was in a femtocell, the Mobility Management Entity (MME) could instead initially page only in the Tracking Area Identities (TAIs) allocated for femtocells that are included in the Tracking Area Identity list for the wireless terminal. If, on the other hand, the last contact was in a macrocell (or macro Tracking Area (TA)), then pager 48 of Mobility Management Entity (MME) 40 could page in the Tracking Areas (TAs) of the entire Tracking Area Identity list without a preceding page in only the TAIs belonging to the femtocell.

The technology disclosed herein thus provides methods and procedure to minimize signaling load from Tracking Area Updating and Paging in conjunction with femtocells (Home eNodeBs). Moreover, providing a multi-staged paging with differing stages having differing paging logic or criteria has the benefit of reducing the paging area, e.g., paging to find the wireless terminal can be enhanced.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” Moreover, it is not necessary for a device or method to address each and every problem sought to be solved by the present invention, for it to be encompassed by the present claims.

What is claimed is:

1. A method of operating a telecommunications network comprising at least one femtocell and at least one macrocell, the at least one femtocell and the at least one macrocell being associated with a Tracking Area, the method comprising:
when a wireless terminal accesses or is about to access a femtocell, including an identifier of the femtocell in a Tracking Area Identity list provided to the wireless terminal whereby the wireless terminal avoids performing a Tracking Area Update when moving between the femtocell and another tracking area included in the Tracking Area Identity list;
when the wireless terminal is to be paged, initially issuing a paging message only to a portion of the cells having corresponding identifiers included in the Tracking Area Identity list.

2. The method of claim 1, further comprising performing the act of including an identifier of the femtocell in the Tracking Area Identity list when the wireless terminal accesses a cell in the vicinity of the femtocell.

3. The method of claim 1, further comprising determining that the wireless terminal is accessing or is about to access the telecommunications network through the femtocell.

4. The method of claim 3, further comprising using configuration information for determining that the wireless terminal is accessing the telecommunications network through the femtocell.

5. The method of claim 3, wherein determining that the wireless terminal is accessing the telecommunications network through the femtocell comprises recognizing a particular interface through which an access occurs as being associated with the femtocell.

6. The method of claim 3, wherein determining that the wireless terminal is accessing the telecommunications network through the femtocell comprises recognizing a base station identifier associated with an access as belonging to a Home eNodeB (HeNB) serving the femtocell.

7. The method of claim 6, further comprising recognizing at least a portion of the base station identifier as being associated with a Home eNodeB gateway.

8. The method of claim 3, wherein determining that the wireless terminal is accessing the telecommunications network through the femtocell comprises recognizing from a Closed Subscriber Group identifier that the wireless terminal is accessing the network through a femtocell.

9. The method of claim 1, further comprising initially issuing a first paging message only to a first set cells comprising one or more femtocells having corresponding identifiers included in the Tracking Area Identity list, and if the wireless terminal does not respond to the first paging message, subsequently issuing a second paging message to another set of cells having corresponding identifiers included in the Tracking Area Identity list.

10. The method of claim 1, further comprising initially issuing a first paging message only to a cell or set of cells having its/their corresponding identifier(s) included in the Tracking Area Identity list and with which the wireless terminal had its last contact, and if the wireless terminal does not respond to the first paging message, issuing a second paging message to another set of cells having corresponding identifiers included in the Tracking Area Identity list.

11. A core network entity configured to communicate with a radio access network comprising at least one femtocell and at least one macrocell, the at least one femtocell and the at least one macrocell being associated with a Tracking Area, the core network entity comprising:
a Tracking Area Identity list builder configured to include an identifier of a femtocell in a Tracking Area Identity list provided to a wireless terminal when the wireless terminal accesses the femtocell, whereby inclusion of the identifier avoids the wireless terminal performing a Tracking Area Update when moving between the femtocell and another tracking area included in the Tracking Area Identity list;
a paging unit configured, when the wireless terminal is to be paged, to initially issue a paging message only to a portion of the cells having corresponding identifiers included in the Tracking Area Identity list.

12. The apparatus of claim 11, wherein the Tracking Area Identity list builder is further configured to include the identifier of the femtocell in the Tracking Area Identity list provided to the wireless terminal when the wireless terminal accesses a cell in the vicinity of the femtocell.

13. The apparatus of claim 11, further comprising an access awareness unit configured to determining that the wireless terminal is accessing the telecommunications network through the femtocell.

14. The apparatus of claim 13, wherein the access awareness unit is configured to use configuration information for determining that the wireless terminal is accessing the telecommunications network through the femtocell.

15. The apparatus of claim 13, wherein the access awareness unit is configured to recognize a particular interface through which an access occurs as being associated with the femtocell.

16. The apparatus of claim 13, wherein the access awareness unit is configured to recognize a base station identifier associated with an access as belonging to a Home eNB (HeNB) serving the femtocell.

17. The apparatus of claim 16, wherein the access awareness unit is configured to recognize at least a portion of the base station identifier as being associated with a HeNB gateway.

18. The apparatus of claim 13, wherein the access awareness unit is configured to recognize by a Closed Subscriber Group identifier that the wireless terminal is accessing the network through a femtocell.

19. The apparatus of claim 12, wherein the paging unit is configured to initially issue a first paging message only to a first set of cells comprising one or more femtocells having corresponding identifiers included in the Tracking Area Identity list, and if the wireless terminal does not respond to the first paging message, to subsequently issue a second paging message to another set of cells having corresponding identifiers included in the Tracking Area Identity list.

20. The apparatus of claim 12, wherein the paging unit is configured to initially issue a first paging message only to a cell or set of cells having its/their corresponding identifier(s) included in the Tracking Area Identity list and with which the wireless terminal had its last contact, and if the wireless terminal does not respond to the first paging message, to subsequently issue a second paging message to another set of cells having corresponding identifiers included in the Tracking Area Identity list
